(19) United States
(12) Patent Application Publication
(10) Pub. No.: US 2015/0113197 A1
(43) Pub. Date: Apr. 23, 2015

(54) DATA STORAGE DEVICE COMPRISING MULTIPLE STORAGE UNITS

(71) Applicant: Western Digital Technologies, Inc., Irvine, CA (US)

(72) Inventors: COLIN W. MORGAN, MISSION VIEJO, CA (US); ALEX Y. TSAY, FREMONT, CA (US); THOMAS J. HITCHNER, SAN MARTIN, CA (US); KENT W. GIBBONS, YORBA LINDA, CA (US)

(73) Assignee: Western Digital Technologies, Inc., Irvine, CA (US)

(21) Appl. No.: 14/102,336

(22) Filed: Dec. 10, 2013

Related U.S. Application Data
(60) Provisional application No. 61/894,370, filed on Oct. 22, 2013.

(51) Int. Cl. G06F 13/40

(52) U.S. Cl. CPC G06F 13/4027; G06F 2213/0026; G06F 2213/0032
USPC 710/313

(57) ABSTRACT

A data storage device including a first storage unit comprising a first media of a first type and an enclosure defining an aperture, a printed circuit board assembly (“PCBA”) located below the first storage unit, wherein the PCBA comprises a bridge unit and a host interface for connecting the data storage device to a host, and a second storage unit located above the first storage unit and comprising a second media of a second type different than the first type and a communications interface configured to be connected to the bridge unit through the aperture.

### CROSS-REFERENCE TO RELATED APPLICATIONS

This application claims the benefit of U.S. Provisional Application No. 61/894,370, filed on Oct. 22, 2013, entitled “STORAGE DEVICE COMPRISING MULTIPLE STORAGE UNITS,” which is hereby incorporated by reference in its entirety.

### BACKGROUND

In a conventional laptop, the conventional laptop may only have space and a connection for a single storage unit. If the storage unit is too slow or does not have enough capacity, the user may replace the storage unit. If the user wants a faster storage unit, the user may utilize a solid state drive. However, the solid state drive may have a lower storage capacity than a hard disk drive. If the user wants greater storage capacity, the user may utilize the hard disk drive instead. However, the hard disk drive may be slower than the solid state drive. Since there is only space and connection for a single storage unit, the user is unable to obtain the benefits of both types of storage units.

### BRIEF DESCRIPTION OF THE DRAWINGS

The features and advantages of the present embodiments will become more apparent from the detailed description set forth below when taken in conjunction with the drawings, wherein:

FIG. 1 depicts an electronic device according to an embodiment;

FIG. 2 is a perspective view of a data storage device according to an embodiment;

FIG. 3 is a perspective view of a data storage device according to an embodiment;

FIG. 4 is a perspective view of a data storage device according to an embodiment;

FIG. 5 is a perspective view of a data storage device according to an embodiment;

FIG. 6 is a side view of a portion of a data storage device according to an embodiment; and

FIG. 7 is a perspective view of a data storage device according to an embodiment.

### DETAILED DESCRIPTION

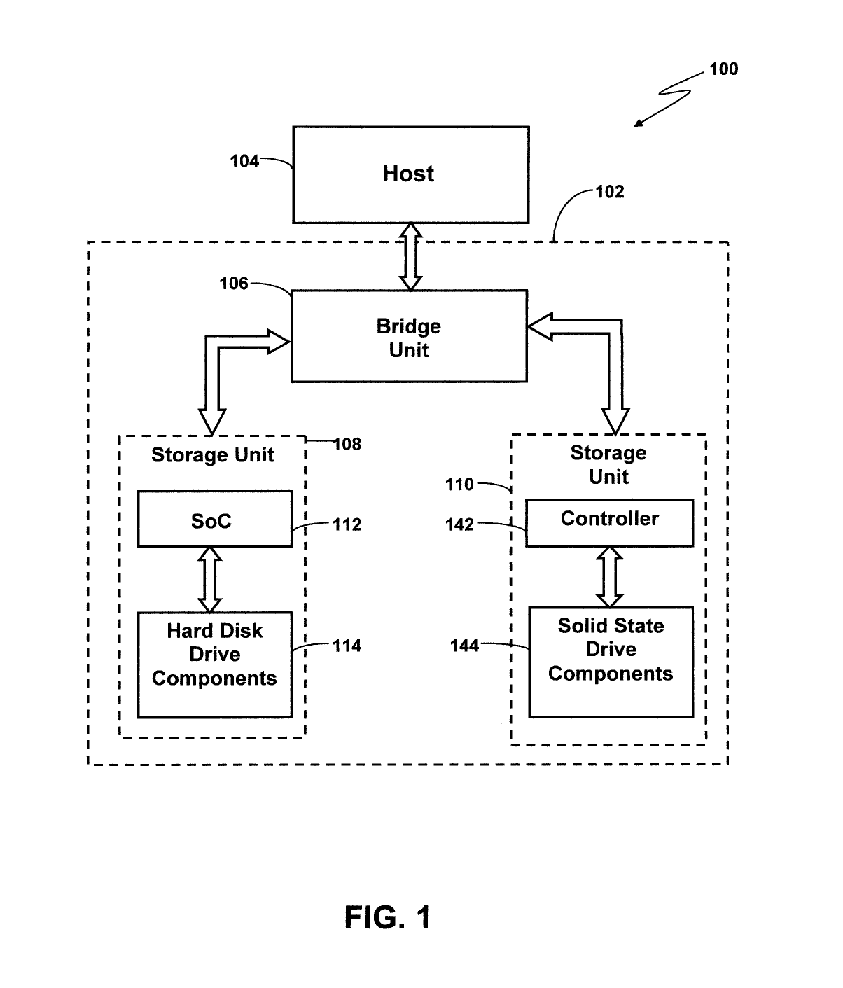

In an embodiment, an electronic device 100 comprises a data storage device 102 and a host 104 as shown in FIG. 1. In an embodiment the electronic device 100 comprises a computer, a laptop, a tablet, a set top box, a portable media player, or any other device which may need to utilize a data storage device comprising multiple storage units. In an embodiment, the electronic device 100 can comprise an enclosure comprising a slot configured to store the data storage device 102. In an embodiment, the data storage device 102 can be located within the electronic device 100. As can be seen in the embodiment shown in FIG. 1, the data storage device 102 is configured to be connected to the host 104.

In an embodiment, the host 104 comprises an electronic device such as a computing system (e.g., desktop, laptop, ultrabook, tablet, gaming system, digital video recorder, etc.). In an embodiment, the data storage device 102 comprises a bridge unit 106, a first storage unit 108, and a second storage unit 110.

In an embodiment, the bridge 106 is configured to connect to the host 104 using a host interface. In the embodiment shown in FIG. 1, the host interface comprises a single interface. In an embodiment, the host interface comprises a serial advanced technology attachment (“SATA”) interface, a universal serial bus (“USB”) interface, a peripheral component interconnect express (“PCIe”) interface, or other types of interface which can allow the host 104 to communicate with the first storage unit 108 and the second storage unit 110.

In an embodiment, the bridge unit 106 is connected to the first storage unit 108 and the second storage unit 110. In an embodiment, the bridge unit 106 is connected to the first storage unit 108 and the second storage unit 110 using one or more communications interfaces. In an embodiment, the communications interface comprises a SATA interface, a USB interface, a PCIe interface, or other types of interface which can allow the bridge unit 106 to communicate with the first storage unit 108 and the second storage unit 110.

In an embodiment, the first storage unit 108 comprises a first media of a first type, and the second storage unit 110 comprises a second media of a second type different than the first type. In an embodiment, the first storage unit 108 comprises a hard disk drive, and the second storage unit 110 comprises a solid state memory.

In an embodiment, the first media comprises a rotating magnetic disk, and the second media comprises a solid state memory. In an embodiment, the first storage unit 108 comprises at least two rotating magnetic disks.

While the description herein refers to solid state memory generally, it is understood that solid state memory may comprise one or more of various types of solid state non-volatile memory devices such as flash integrated circuits, Chalcogenide RAM (C-RAM), Phase Change Memory (PC-RAM or PRAM), Programmable Metallization Cell RAM (PMC-RAM or PMCm), Ovonic Unified Memory (OUM), Resistance RAM (RRAM), NAND memory (e.g., single-level cell (SLC) memory, multi-level cell (MLC) memory, or any combination thereof), NOR memory, EEPROM, Ferroelectric Memory (FeRAM), Magnetoresistive RAM (MRAM), other discrete NVM (non-volatile memory) chips, or any combination thereof

Thus, in an embodiment, the first storage unit 108 comprises a system on chip (“SoC”) 112 and hard disk drive components 114 while the second storage unit 108 comprises a controller 142 and solid state drive components 144. In an embodiment, the SoC 112 is utilized to interface with the bridge unit 106 and can control the operations of the hard disk drive components 114. The hard disk drive components 114 can comprise, for example, the first media, and additional components to write data to or read data from the first media such as some or all components of a head stack assembly (“HSA”).

In an embodiment, the controller 142 is utilized to interface with the bridge unit 106 and can control the operations of the solid state drive components. The solid state drive components 144 can comprise, for example, the second media, and additional components to write data to or read data from the second media.

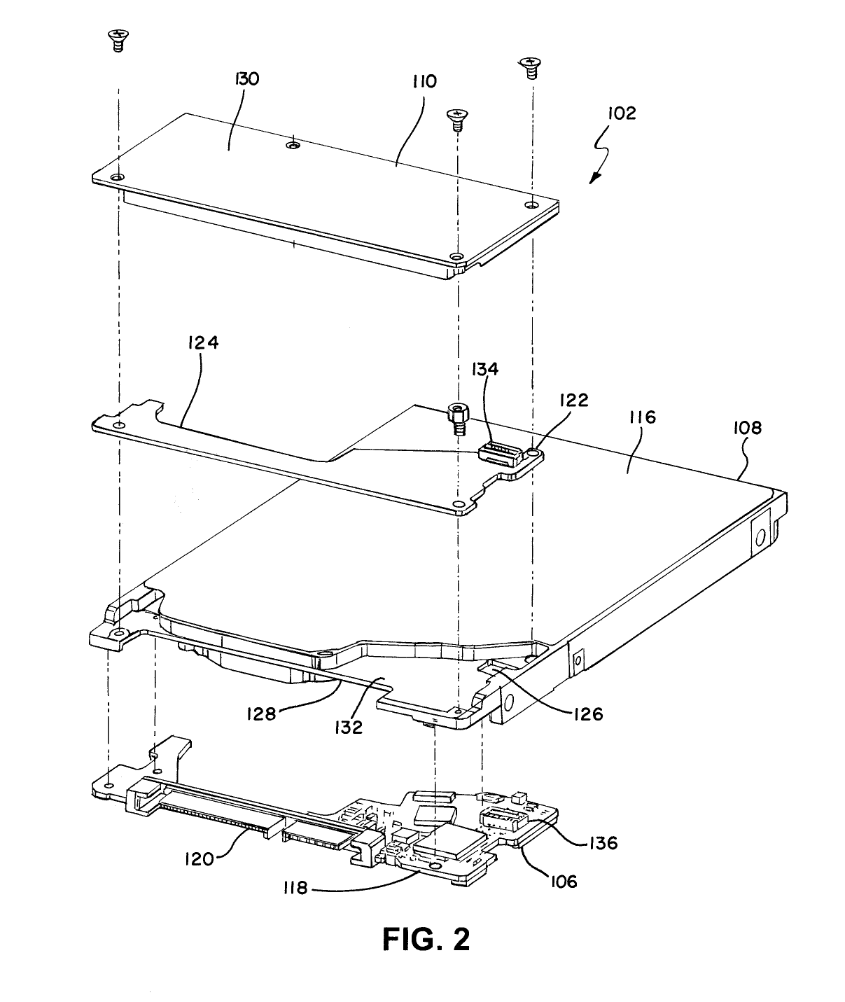

In an embodiment, a perspective view of the data storage device 102 is shown in FIG. 2. As see in the embodiment shown in FIG. 2, from bottom to top, the data storage device 102 comprises a printed circuit board assembly (“PCBA”) 118, the first storage unit 108, an interconnect unit 122, and the second storage unit 110. In an embodiment, the PCBA 118 comprises the SoC 112 (FIG. 1), the bridge unit 106 (FIG. 1), and a host interface 120. In an embodiment, the host interface 120 can be separate from the bridge unit 106. However, in an embodiment, the host interface 120 can be part of or integrated with the bridge unit 106.

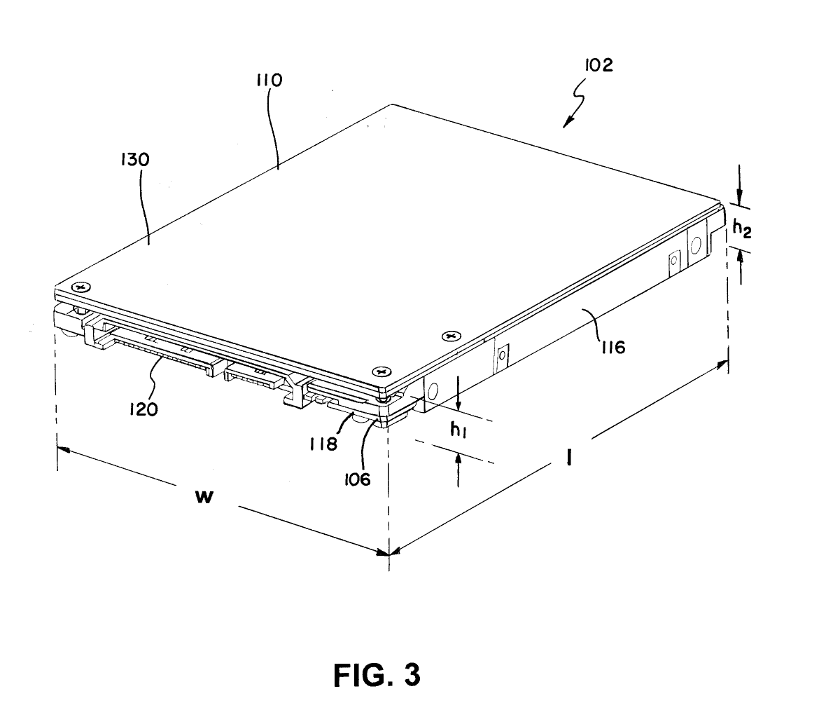

In an embodiment shown in FIG. 2, the bridge unit 106 comprises a communications interface 136. Although in the embodiment shown in FIG. 2, the second storage unit 110 partially covers the first storage unit 108, in the embodiment shown in FIG. 3, the second storage unit 110 covers or substantially covers the first storage unit 108.

In an embodiment, the first storage unit 108 comprises an enclosure 116. In an embodiment, the height, width, and length of the data storage device 102 conforms to a storage device standard, such as those published by the Small Form Factor (SFF) Committee. In an embodiment, the storage device standard comprises the SFF-8201 standard. The storage device standard can govern, for example, physical parameters of the data storage device 102 such as the height, width, and length of the data storage device 102.

In an embodiment shown in FIG. 3, the storage device comprises a height h₁, a width w, and a length l. Furthermore, the first storage unit comprises a height h₂. In an embodiment, the storage device comprises a height h₁ of approximately 9.5 mm. That is, from a bottom of the first storage unit 108, to a top of the second storage unit 110, the storage device comprises a height of 9.5 mm. In an embodiment, the first storage unit 110 comprises a height h₂ of approximately 7 mm. In an embodiment, the data storage device 102 comprises a height h₁ of approximately 7 mm. In an embodiment, the first storage unit 110 comprises a height h₂ of approximately 5 mm.

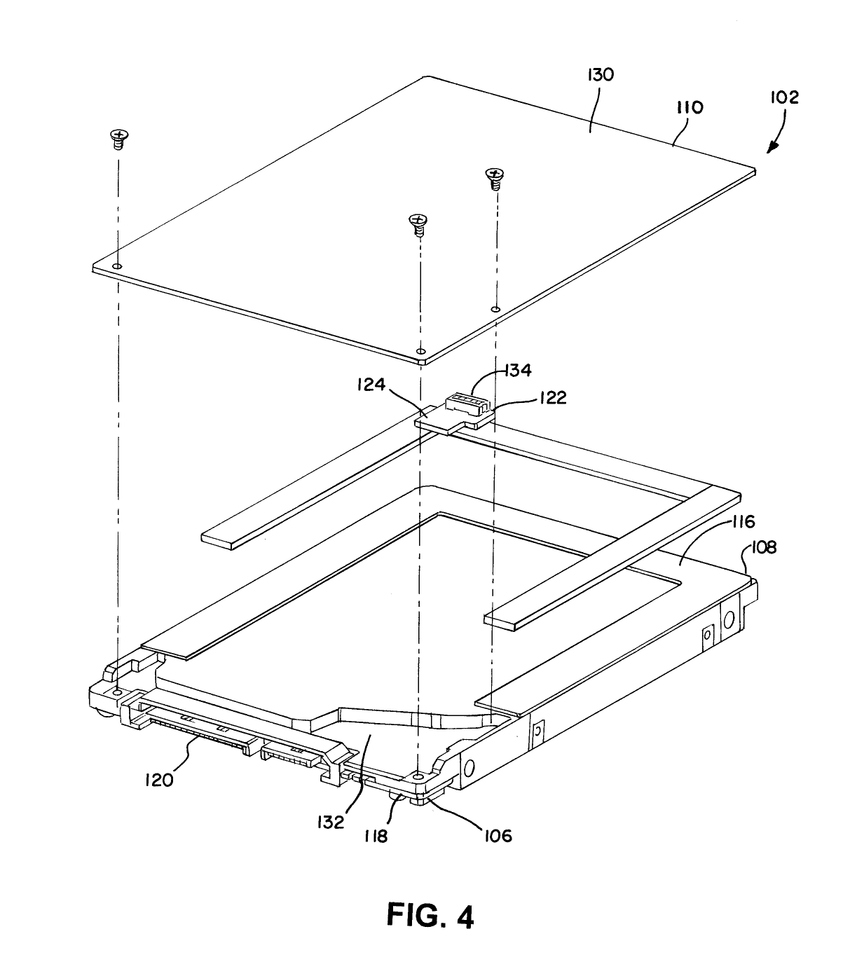

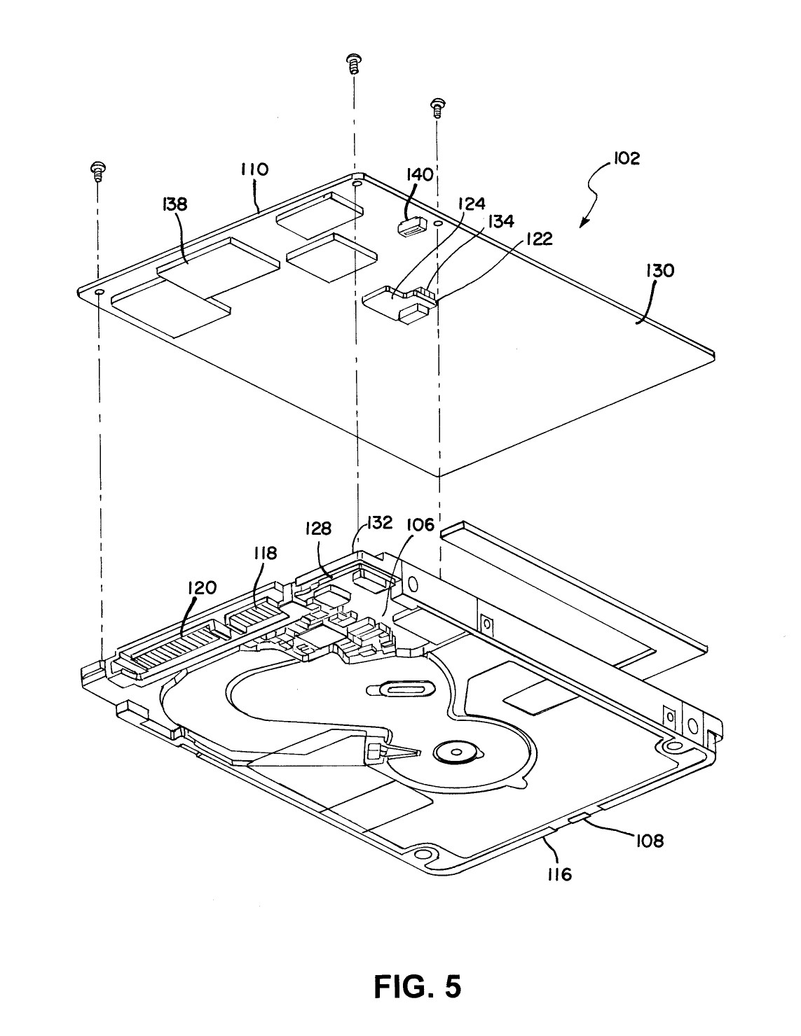

Referring back to FIG. 2, in an embodiment, the enclosure 116 comprises a first indentation 128 on a bottom side of the enclosure. In an embodiment, the PCBA 118 is configured to be placed in the first indentation 128, as shown in an embodiment in FIG. 5. In an embodiment shown in FIGS. 2, 4 and 5, the enclosure 116 comprises a second indentation 132 on a top side of the enclosure 116. In an embodiment, the interconnect unit 122 is located in the second indentation 132. In an embodiment, the interconnect unit 122 comprises a communications interface 134. Furthermore in the embodiment shown in FIG. 2, the interconnect unit 122 is located on an optional standoff board 124. In an embodiment, the standoff board 124 can also comprise memory components in order to increase overall capacity of the data storage device 102. In an embodiment shown in FIG. 4, the interconnect unit 122 is located on a smaller standoff board 124. In an embodiment, the use of the smaller standoff board 124 can reduce manufacturing costs of the data storage device 102 and/or the electronic device 100.

Referring back to the embodiment shown in FIG. 2, the communications interface 134 of the interconnect unit 122 is configured to be connected to the PCBA 118. In an embodiment, the enclosure 116 defines an aperture 126 to allow the communications interface 134 of the interconnect unit 122 to be connected to the PCBA 118.

In an embodiment, second storage unit 110 is configured to be located above the enclosure 116 and the interconnect unit 122. In an embodiment shown in FIG. 5, the second storage unit 110 comprises a circuit board 130, memory components 138 and a communications interface 140. In an embodiment, the circuit board 130 comprises a top surface and a bottom surface. The bottom surface of the circuit board 130 can be configured to face the first storage unit 108. In an embodiment, the memory components 138 and the communications interface 140 are located on the bottom surface of the circuit board 130. In an embodiment, the top surface of the circuit board 130 is substantially planar. In an embodiment shown in FIG. 2, the circuit board 130 partially covers the first storage unit 108, while in the embodiment shown in FIG. 3, the circuit board 130 covers or substantially covers the first storage unit 108.

In an embodiment, the memory components 138 can be part of the solid state drive components 144. The communications interface 140 can be configured to be connected to the PCBA 118 through the communications interface 134 of the interconnect unit 122. In an embodiment, the second storage unit 110 is configured to connect with the bridge unit 106 located in the PCBA 118.

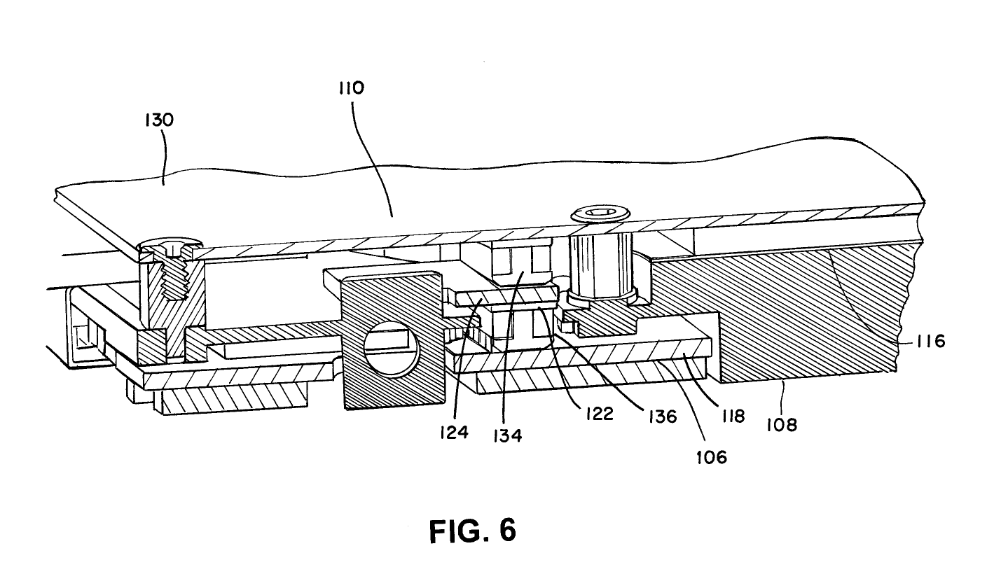

In an embodiment, a partial side view of the data storage device 102 is shown in FIG. 6. As can be seen in the embodiment shown in FIGS. 1 and 6, the communications interface 140 is connected to the bridge unit 106 through the communications interface 134 and the communications interface 136. However, in an embodiment, the communications interface 140 may be configured to be connected directly to the communications interface 136. In such a case, the interconnect unit 122 and the communications interface 134 would not be needed.

In an embodiment, when the data storage device 102 is connected to the host 104, the host 104 can recognize not just one storage unit, but both the first storage unit 108 and the second storage unit 110. In an embodiment, the host 104 is configured to initialize the data storage device 102 based at least partly on an initialization query. In an embodiment, the host 104 comprises a Basic Input/Output System (“BIOS”), which can provide the initialization query. In an embodiment, the first storage unit 108 is not identified to the host 104 when a driver is not installed in the host 104. Thus, only the second storage unit 110 is identified to the host 104 when the driver is not installed in the host 104. However, when the driver is installed in the host 104, the first storage unit 108 and the second storage unit 110 are identified to the host 104.

In an embodiment, the identification of the first storage unit 108 and/or the second storage unit 110 can be provided by the controller 142 in the second storage unit 110 in response to the initialization query by the host 104. In an embodiment, the driver can provide an indication comprising a signature to the controller 142. Upon reception of the indication, the controller 142 can provide the identification of both the first storage unit 108 and the second storage unit 110. In an embodiment the host 104 recognizes the first storage unit 108 and the second storage unit 110 as individual volumes.

In an embodiment, the identification of the first storage unit 108 and the second storage unit 110 can also be reversed. That is, the second storage unit 110 is not identified to the host 104 when a driver is not installed in the host 104. In such a case, the SoC 112 in the first storage unit 108 may provide identification of the first storage unit 108 and/or the second storage unit 110 to the host 104.

In an embodiment, this can increase a storage capacity of the data storage device 102. Furthermore, a speed of the data storage device can be increased due to the hybrid nature of the data storage device 102. In an embodiment, this is beneficial to a user because the user may be limited to just a single host interface to connect the data storage device 102 to the host 104.

Furthermore, compliance with the storage device standards allows for the data storage device 102 comprising at least two storage units to physically fit into a storage device slot where the storage device slot would normally only be able to accommodate a data storage device comprising only a single storage unit.

In the embodiments shown in FIGS. 2-6, the first storage unit 108, the second storage unit 110, the interconnect unit 122, and the PCBA 118 are presented in a certain order from bottom to top for the data storage device 102. However, in an embodiment, the second storage unit 110, the interconnect unit 122, and the PCBA 118 may be arranged in other orders for the data storage device 102.

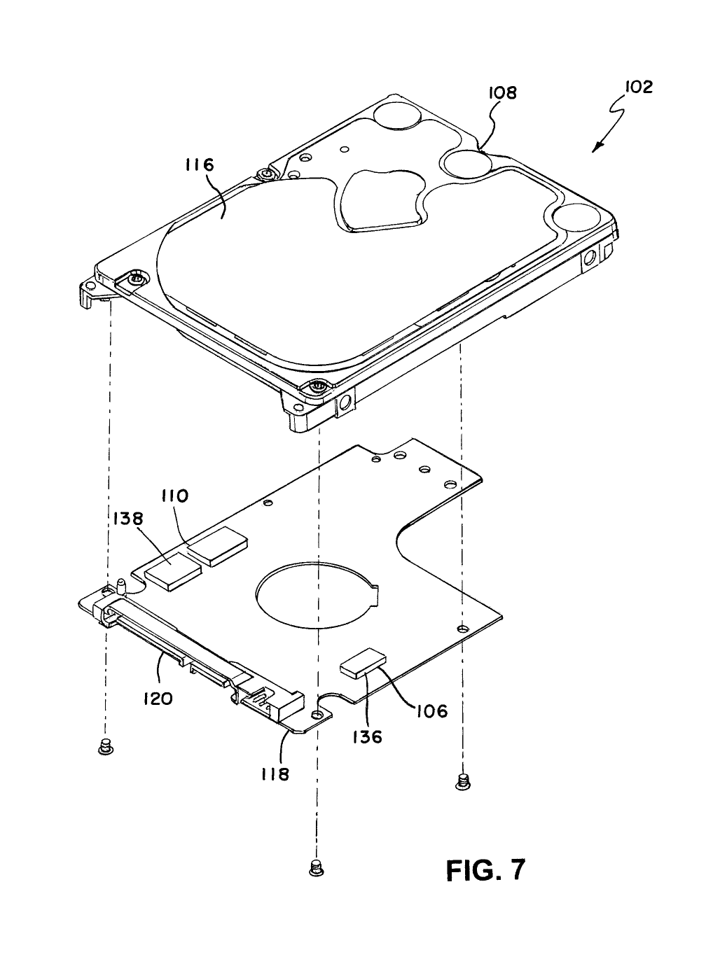

In an embodiment shown in FIG. 7, the PCBA 118 comprises the second storage unit 110. Thus, the memory components 138 for the second storage unit 110 are located in the PCBA 118. In an embodiment this can further reduce a height of the data storage device 102. Furthermore, in an embodiment, the PCBA 118 need not be located in the first indentation 128. Instead, the PCBA 118 can be located below the enclosure 116. In an embodiment, an optional communications interface 136 in the bridge unit 106 can be configured to provide a connection between the bridge unit 106 and the first storage unit 108 and/or the second storage unit 110.

In an embodiment, the enclosure 116 need not include the first indentation 128, the second indentation 132, or the aperture 126. In addition, the data storage device 102 need not include the interconnect unit 122 since the second storage unit 110 does not need to utilize the interconnect unit 122 to connect to the bridge unit 106. In an embodiment the removal of these components or features can reduce manufacturing costs.

In the embodiment shown in FIG. 7, the PCBA 118 is located below the enclosure 116 of the first storage unit 108. However, in an embodiment, the PCBA 118 can be located above the enclosure 116 of the first storage unit 108.

Those of ordinary skill would appreciate that the various illustrative logical blocks, modules, and algorithm parts described in connection with the examples disclosed herein may be implemented as electronic hardware, computer software, or combinations of both. Furthermore, the embodiments can also be embodied on a non-transitory machine readable medium causing a processor or computer to perform or execute certain functions.

To clearly illustrate this interchangeability of hardware and software, various illustrative components, blocks, modules, circuits, and process parts have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed apparatus and methods.

The parts of a method or algorithm described in connection with the examples disclosed herein may be embodied directly in hardware, in a software module executed by a processor, or in a combination of the two. The parts of the method or algorithm may also be performed in an alternate order from those provided in the examples. A software module may reside in RAM memory, flash memory, ROM memory, EPROM memory, EEPROM memory, registers, hard disk, a removable disk, an optical disk, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC).

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the disclosure is, therefore, indicated by the appended claims rather than by the foregoing description. All changes which come within the meaning and range of equivalency of the claims are to be embraced within their scope.

What is claimed is:

1. A data storage device comprising:
a first storage unit comprising a first media of a first type and an enclosure defining an aperture;
a printed circuit board assembly (“PCBA”) located below the first storage unit, wherein the PCBA comprises a bridge unit and a host interface for connecting the data storage device to a host; and
a second storage unit located above the first storage unit and comprising a second media of a second type different than the first type and a communications interface configured to be connected to the bridge unit through the aperture.

2. The data storage device of claim 1 wherein the enclosure comprises a first indentation on a top side of the enclosure, and a second indentation on a bottom side of the enclosure, wherein the PCBA is located on the second indentation.

3. The data storage device of claim 2 further comprising an interconnect unit located in the first indentation, wherein the interconnect unit is configured to connect the communications interface of the second storage unit with the bridge unit.

4. The data storage device of claim 3 further comprising a standoff board, wherein the interconnect unit is located on the standoff board.

5. The data storage device of claim 4 wherein the standoff board further comprises memory components.

6. The data storage device of claim 1 wherein the second storage unit further comprises:
memory components; and
a circuit board comprising a top surface and a bottom surface, wherein the bottom surface is configured to face the first storage unit, and the memory components are located on the bottom surface of the circuit board.

7. The data storage device of claim 6 wherein the top surface of the circuit board is substantially planar.

8. The data storage device of claim 1 wherein the first media comprises a rotating magnetic disk, and the second media comprises a solid state memory.

9. The data storage device of claim 8 wherein the first media comprises at least two rotating magnetic disks.

10. The data storage device of claim 1 wherein the data storage device comprises a height of approximately 9.5 mm, and the first storage unit comprises a height of approximately 7 mm.

11. The data storage device of claim 1 wherein the data storage device comprises a height of approximately 7 mm, and the first storage unit comprises a height of approximately 5 mm.

12. The data storage device of claim 1 wherein the host interface and the bridge unit are configured to allow the host to recognize the first storage unit and the second storage unit as two separate storage units through the host interface.

13. The data storage device of claim 1 wherein the host interface comprises a serial advanced technology attachment (“SATA”) interface.

14. An electronic device comprising:
a host; and
a data storage device configured to be connected to the host comprising:
a first storage unit comprising a first media of a first type and an enclosure defining an aperture;
a printed circuit board assembly (“PCBA”) located below the first storage unit, wherein the PCBA comprises a bridge unit and a single host interface for connecting the data storage device to the host; and
a second storage unit located above the first storage unit and comprising a second media of a second type different than the first type and a communications interface configured to be connected to the bridge unit through the aperture.

15. The electronic device of claim 14 wherein the enclosure comprises a first indentation on a top side of the enclosure, and a second indentation on a bottom side of the enclosure, wherein the PCBA is located on the second indentation.

16. The electronic device of claim 15 wherein the data storage device further comprises an interconnect unit located in the first indentation, wherein the interconnect unit is configured to connect the communications interface of the second storage unit with the bridge unit.

17. The electronic device of claim 14 wherein the second storage unit further comprises:
memory components; and
a circuit board comprising a top surface and a bottom surface, wherein the bottom surface is configured to face the first storage unit, and the memory components are located on the bottom surface of the circuit board.

18. The electronic device of claim 17 wherein the top surface of the circuit board is substantially planar.

19. The electronic device of claim 14 wherein the first media comprises a rotating magnetic disk, and the second media comprises a solid state memory.

20. The electronic device of claim 19 wherein the first media comprises at least two rotating magnetic disks.

21. The electronic device of claim 14 wherein the single host interface and the bridge unit are configured to allow the host to recognize the first storage unit and the second storage unit as two separate storage units.

22. A data storage device comprising:
a first storage unit comprising a first media of a first type;
a printed circuit board assembly (“PCBA”) located below the first storage unit and comprising:
a bridge unit configured to be connected to the first storage unit;
a host interface for connecting the data storage device to a host; and
a second storage unit comprising a second media of a second type different than the first type and configured to be connected to the bridge unit.
